(19) United States
(12) Patent Application Publication
(10) Pub. No.: US 2024/0161540 A1
(43) Pub. Date: May 16, 2024

(54) FLEXIBLE LANDMARK DETECTION

(71) Applicant: DISNEY ENTERPRISES, INC., Burbank, CA (US)

(72) Inventors: Derek Edward BRADLEY, Zurich (CH); Prashanth CHANDRAN, Zurich (CH); Paulo Fabiano URNAU GOTARDO, Zurich (CH); Gaspard ZOSS, Zurich (CH)

(21) Appl. No.: 18/505,017

(22) Filed: Nov. 8, 2023

Related U.S. Application Data
(60) Provisional application No. 63/383,455, filed on Nov. 11, 2022.

(51) Int. Cl. G06V 40/16; G06T 7/11; G06T 7/20; G06T 17/00

(52) U.S. Cl. CPC G06V 40/171; G06T 7/11; G06T 7/20; G06T 17/00; G06T 2207/30201; G06V 2201/07

(57) ABSTRACT

One or more embodiments comprise a computer-implemented method that includes receiving an input image including one or more facial representations and a set of points on a 3D canonical shape, wherein the set of points are selectable at runtime, extracting a set of features from the input image that represent at least one facial representation included in the one or more facial representations, and determining a set of landmarks on the at least one facial representation based on the set of features and the set of points, wherein each landmark in the set of landmarks is associated with at least one point in the set of points.

### CROSS-REFERENCE TO RELATED APPLICATIONS

This application claims priority benefit to U.S. provisional application titled “CONTINUOUS FACIAL LANDMARK DETECTION,” filed on Nov. 11, 2022, and having Ser. No. 63/383,455. This related application is also hereby incorporated by reference in its entirety.

### BACKGROUND

### Field of the Various Embodiments

The various embodiments relate generally to landmark detection on images and, more specifically, to techniques for flexible landmark detection on images at runtime.

### DESCRIPTION OF THE RELATED ART

Many computer vision and computer graphics applications rely on landmark detection on images. Such applications include three-dimensional (3D) facial reconstruction, tracking, face swapping, segmentation, re-enactment, or the like. Landmarks, such as facial landmarks, can be used as anchoring points for models, such as, 3D face appearance or autoencoders. Locations of landmarks are used, for instance, to spatially align faces. In some applications, facial landmarks are important for enabling visual effects on faces, for tracking eye gaze, or the like.

Some approaches for facial landmark detection involve deep learning techniques. These techniques can generally be categorized into main types: direct prediction methods and heatmap prediction methods. In direct prediction methods, the x and y coordinates of the various landmarks are directly predicted by processing facial images. In heatmap prediction methods, the distribution of each landmark is first predicted and then the location of each landmark is extracted by maximizing that distribution function.

One drawback to these approaches is that the predicted landmarks are fixed and follow a pre-determined layout. For example, facial landmarks are often predicted as a set of 68 sparse landmarks spread across the face in a specific and predefined layout. In typical approaches, the number and layout of the landmarks ahead of time and cannot be modified dynamically at runtime. This forces existing methods to only train on datasets with compatible landmarks layout whereas a method with flexible layout at runtime can accommodate any desired downstream application.

Accordingly, there is a need for techniques that enable landmark detection in a flexible layout specified at runtime.

### SUMMARY

One or more embodiments comprise a computer-implemented method that includes receiving an input image including one or more facial representations and a set of points on a 3D canonical shape, wherein the set of points are selectable at runtime, extracting a set of features from the input image that represent at least one facial representation included in the one or more facial representations, and determining a set of landmarks on the at least one facial representation based on the set of features and the set of points, wherein each landmark in the set of landmarks is associated with at least one point in the set of points.

One technical advantage of the disclosed technique relative to the prior art is that the disclosed technique allows for landmarks to be generated according to a layout that is selected at runtime. In such a manner, landmarks can be predicted on input images in a continuous and arbitrary manner that satisfies a given application's requirement. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a schematic diagram illustrating a computing system configured to implement one or more aspects of the present disclosure.

FIG. 2 is a more detailed illustration of the training engine and execution engine of FIG. 1, according to various embodiments of the present disclosure.

FIG. 3 is a more detailed illustration of the execution engine of FIG. 1, according to various embodiments of the present disclosure.

FIG. 4 illustrates the application of landmark detection engine in FIG. 2 to facial segmentation, according to various embodiments.

FIG. 5 illustrates the application of landmark detection engine in FIG. 2 to user-specific landmark tracking, according to various embodiments.

FIG. 6 illustrates the application of landmark detection engine in FIG. 2 to face tracking in Helmet-Mounted Camera (HMC) images, according to various embodiments.

FIG. 7 illustrates an application of landmark detection engine in FIG. 2 for predicting non-standard volumetric landmarks, according to various embodiments.

FIG. 8 illustrates an application of landmark detection engine in FIG. 2 for 2D face editing, according to various embodiments.

FIG. 9 illustrates an application of landmark detection engine in FIG. 2 for 3D facial performance reconstruction, according to various embodiments.

FIG. 10 is a flow diagram of method steps for predicting landmark locations, according to various embodiments.

FIG. 11 is a flow diagram of method steps for training a landmark detection model, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

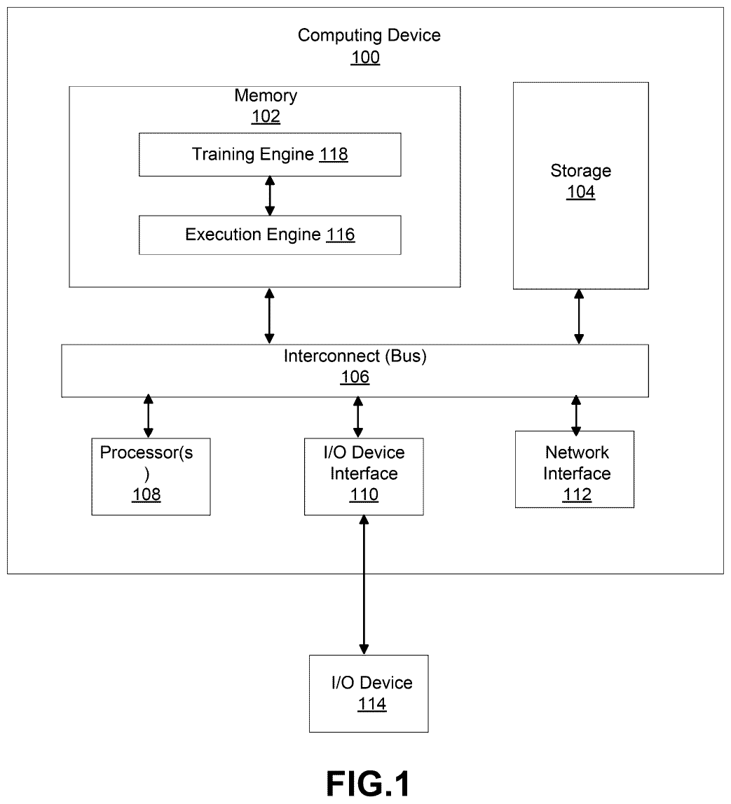

FIG. 1 illustrates a computing device 100 configured to implement one or more aspects of the present disclosure. As shown, computing device 100 includes an interconnect (bus) 106 that connects one or more processor(s) 108, an input/output (I/O) device interface 110 coupled to one or more input/output (I/O) devices 114, memory 102, a storage 104, and a network interface 112.

Computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 described herein is illustrative and any other technically feasible configurations fall within the scope of the present disclosure.

Processor(s) 108 includes any suitable processor implemented as a central processing unit (CPU), a graphics processing unit (GPU), an application-specific integrated circuit (ASIC), a field programmable gate array (FPGA), an artificial intelligence (AI) accelerator, any other type of processor, or a combination of different processors, such as a CPU configured to operate in conjunction with a GPU. In general, processor(s) 108 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O device interface 110 enables communication of I/O devices 114 with processor(s) 108. I/O device interface 110 generally includes the requisite logic for interpreting addresses corresponding to I/O devices 114 that are generated by processor(s) 108. I/O device interface 110 may also be configured to implement handshaking between processor(s) 108 and I/O devices 114, and/or generate interrupts associated with I/O devices 114. I/O device interface 110 may be implemented as any technically feasible CPU, ASIC, FPGA, any other type of processing unit or device.

In one embodiment, I/O devices 114 include devices capable of providing input, such as a keyboard, a mouse, a touch-sensitive screen, and so forth, as well as devices capable of providing output, such as a display device. Additionally, I/O devices 114 may include devices capable of both receiving input and providing output, such as a touchscreen, a universal serial bus (USB) port, and so forth. I/O devices 114 may be configured to receive various types of input from an end-user (e.g., a designer) of computing device 100, and to also provide various types of output to the end-user of computing device 100, such as displayed digital images or digital videos or text. In some embodiments, one or more of I/O devices 114 are configured to couple computing device 100 to a network 112.

Network 112 includes any technically feasible type of communications network that allows data to be exchanged between computing device 100 and external entities or devices, such as a web server or another networked computing device. For example, network 112 may include a wide area network (WAN), a local area network (LAN), a wireless (WiFi) network, and/or the Internet, among others.

Storage 104 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 118 and execution engine 116 may be stored in storage 104 and loaded into memory 102 when executed.

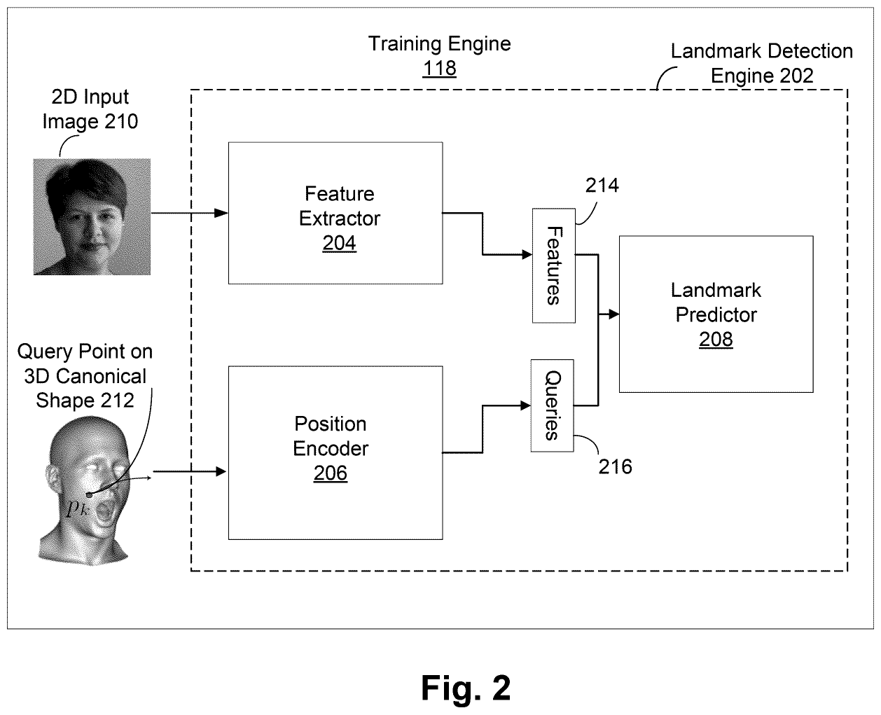

Memory 102 includes a random access memory (RAM) module, a flash memory unit, or any other type of memory unit or combination thereof. Processor(s) 108, I/O device interface 110, and network interface 112 are configured to read data from and write data to memory 102. Memory 102 includes various software programs that can be executed by processor(s) 108 and application data associated with said software programs, including training engine 118 and execution engine 116. Training engine 118 and execution engine 116 are described in further detail below with respect to FIG. 2.

FIG. 2 is a more detailed illustration of training engine 118 of FIG. 1, according to various embodiments of the present disclosure. As shown, training engine 118 includes, without limitation, landmark detection engine 202. Landmark detection engine 202 includes a feature extractor 204, a position encoder 206 and a landmark predictor 208.

Landmark detection engine 202 determines one or more landmarks for a given input image. In various embodiments, a landmark is a distinguishing characteristic or point of interest in an image. In various embodiments, landmarks are specified as a 2D coordinate (e.g., an x-y coordinate) on an image. Examples of facial landmarks include the inner or outer corners of the eyes, the inner or outer corners of the mouth, the inner or outer corners of the eyebrows, the tip of the nose, the tips of the ears, the location of the nostrils, the location of the chin, the corners or tips of other facial marks or points, or the like. Any number of landmarks can be determined for each facial feature such as the eyebrows, right and left centers of the eyes, nose, mouth, ears, chin, or the like. In some embodiments, additional landmarks can be interpolated between one or more facial landmarks or points. In some embodiments, a user can arbitrarily design the desired landmark layout and density. In some embodiments, the landmarks density or localization depends on one or more pixel intensity patterns around one or more facial characteristics. The pixel intensities and their arrangement carry information about the contents of the image and describe difference of facial features.

Feature extractor 204 included in landmark detection engine 202 extracts a set of features from an input image, where the set of features is used by downstream components to determine the landmarks for the input image. In various embodiments, feature extractor includes any technically feasible machine learning model(s). Examples of the machine learning model(s) include convolutional neural networks (CNNs), deep neural networks (DNNs), deep convolutional networks (DCNs), and/or other types of artificial neural networks or components of artificial neural networks.

In some embodiments, feature extractor 204 includes a feature model fθ, which is parameterized by θ in such a way as to be trainable by gradient-descent methods or the like. Feature extractor 204 determines a set of features associated with an input image based on the following equation:

f_{θ}(I)=[P₁(I), . . . ,Pₙ(I)], with Pᵢ∈R^{d} (1)

In the above equation, for an input image I, feature model ƒ_{θ} is used to compute a set of n features. While I can be an argument to the function ƒ_{θ}, I can also serve as an index on the set of features output by ƒ_{θ}·P₁(I), . . . Pₙ(I) represents the set of d-dimensional image descriptors for input image I. In various embodiments, image descriptors are elementary visual features of images like shape, color, texture or motion. Image descriptors can also be facial identity, expressions, combinations thereof, or any abstract representation describing the image in enough detail to extract facial landmarks. d is the dimension of the feature vector (i.e., the set of features) output by feature extractor 204.

Position encoder 206 maps positions on a 3D template (also referred to as “canonical shape C”) to position queries that are used by landmark predictor 208 to generate the desired landmarks. Position queries inform landmark predictor 208 of the specific landmarks that should be predicted for the input image. In various embodiments, the canonical shape C is a fixed template face from which 3D position queries are sampled. The layout of these 3D position queries can be chosen or modified by the user at runtime.

In various embodiments, any 3D position pₖ corresponding to a desired output landmark Iₖ is sampled from canonical shape C and position encoded to obtain position query qₖ∈R^{B}. Position encoding is the process of representing structured data associated with a given position on the canonical shape C in a lower dimensional format. In some embodiments, position encoder 206 is a 2-layer multi-layer perceptron that is trained to map a 3D position pₖ to a corresponding position query qₖ. Since the 3D positions on 3D canonical shape C can be selected arbitrarily, the output landmarks are continuous and, thus, an unlimited number of landmarks can be determined for the input image This feature enables sampling 3D positions off the surface of the canonical shape C, yielding 2D landmark tracking for volumetric objects like bones. These volumetric landmarks can be used to fit anatomical shapes on the input image.

Landmark predictor 208 predicts, for each 3D position query, the corresponding 2D position on the input image that represents a given desired landmark. Landmark predictor 208 generates an output image that includes a representation of each of the desired landmarks at their corresponding 2D positions on the input image. In various embodiments, the input to landmark predictor 208 is a concatenated representation of the positional queries generated by position encoder 206 and the feature vector associated with input image determined by feature extractor 204. For each positional query, landmark predictor 208 outputs a 2D position corresponding to a given desired landmark and a scalar confidence value, which indicates how confident landmark predictor 208 is about the predicted landmark location.

In some embodiments where multiple output landmarks are predicted for the same input image, the feature vector associated with the image is duplicated n times (given n landmarks) and concatenated with the n position queries [q₀, q₁, . . . , qₙ₋₁]. In various embodiments, the feature vector remains the same irrespective of the landmarks predicted on the output side.

Training engine 118 trains or retrains machine learning models in landmark detection engine 202, such as feature extractor 204, position encoder 206, and landmark predictor 208. During training, input image I includes an image selected from storage 114. In some embodiments, input image(s) 120 includes images divided into training datasets, testing datasets, or the like. In other embodiments, the training data set is divided into minibatches, which include small, non-overlapping subsets of the dataset. In some embodiments, input image(s) include labeled images, high-definition images (e.g., resolution above 1000×1000 pixels), images with indoor or outdoor footage, images with different lighting and facial expressions, images with variations in poses and facial expressions, images of faces with occlusions, images labelled or re-labelled with a set of landmarks (e.g., 68-point landmarks, 70-point landmarks, or dense landmarks with 50000-point landmarks), video clips with one or more frames annotated with a set of landmarks (e.g., 68 landmarks), images with variations in resolution, videos with archive grayscale footage, or the like. In some embodiments different canonical shapes can be chosen for training of landmark detection engine 202 to represent different facial expressions. In some embodiments, the landmark detection engine 202 is trained with data augmentations that makes the resulting landmark detection engine 202 more robust landmark detection engine 202 in an end-to-end fashion using a Gaussian negative log likelihood loss function. In each training iteration, landmark detection engine 202 receives an input image from storage 104 and one or more position queries associated with the canonical shape C. Landmark detection engine 202 processes the input image and position queries to generate a set of 2D positions on the input image corresponding to the desired landmarks. In addition to a set of 2D positions on the input image, landmark detection engine 202 also generates a scalar confidence value for each landmark. Predicting scalar confidence values for each landmark enables training engine 118 to calculate the loss using Gaussian negative log likelihood loss function. The loss is used to update trainable parameters associated with the landmark detection engine 202. In various embodiments, the Gaussian negative log likelihood does not require the ground truth for scalar confidence values. In one embodiment, training proceeds in batches with sparse and dense landmarks to train all networks simultaneously. Training engine 118 repeats the training process for multiple iterations until a threshold condition is achieved.

In some embodiments, training engine 118 trains landmark detection engine 202 using one or more hyperparameters. Each hyperparameter defines “higher-level” properties of landmark detection engine 202 instead of internal parameters of landmark detection engine 202 that are updated during training of landmark detection engine 202 and subsequently used to generate predictions, inferences, scores, and/or other output of landmark detection engine 202. Hyperparameters include a learning rate (e.g., a step size in gradient descent), a convergence parameter that controls the rate of convergence in a machine learning model, a model topology (e.g., the number of layers in a neural network or deep learning model), a number of training samples in training data for a machine learning model, a parameter-optimization technique (e.g., a formula and/or gradient descent technique used to update parameters of a machine learning model), a data-augmentation parameter that applies transformations to features inputted into landmark detection engine 202 (e.g., scaling, translating, rotating, shearing, shifting, and/or otherwise transforming an image), a model type (e.g., neural network, clustering technique, regression model, support vector machine, tree-based model, ensemble model, etc.), or the like.

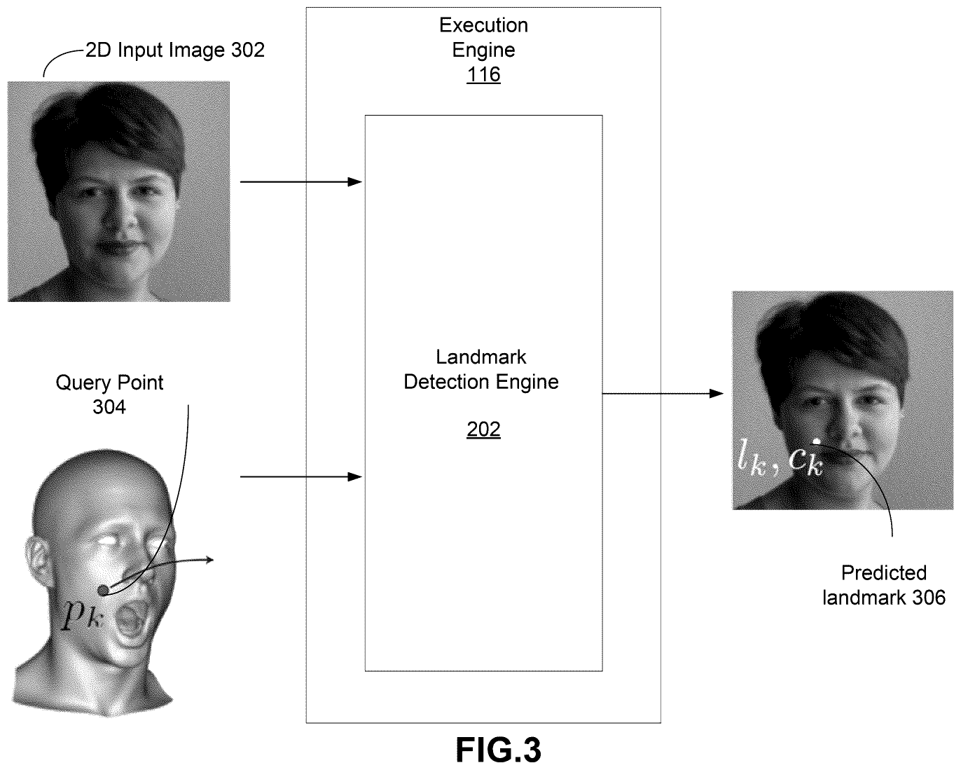

FIG. 3 is a more detailed illustration of execution engine 116 of FIG. 1, according to various embodiments of the present disclosure. As shown, landmark detection engine 202 executes within execution engine 116.

Landmark detection engine 202 receives a 2D input image 302 and one or more query points 304 on the canonical shape. 2D input image 302 can be any image of a person's face captured by any image capture device, such as a camera. In some embodiments, 2D input image 302 can be a frame within a video. Each of the query points represents the coordinates of a selected point on a canonical shape. As discussed above, a canonical shape is a volumetric or surface-based 3D shape of a human face. Any point inside or on the surface of a volumetric shape can be queried by selecting a position on the canonical shape. In some embodiments, the canonical shape represent a unisex human face with an open mouth or closed mouth, open eyes or closed eyes, or any other facial expressions. In some embodiments multiple query points are selected as input to the landmark detection engine 202. In some embodiments, for a given image annotated with 2D landmarks, a set of corresponding query points on the canonical shape are determined via a query optimization process. The set of corresponding query points are used to predict landmarks on a different 2D input image, where the predicted landmarks correspond to the landmarks on the annotated image.

Landmark detection engine 202 generates the predicted landmark on the 2D image 306 based on the 2D input image 302 and the query point 304. The coordinates of the predicted landmark 306 on the output 2D image correspond to query point 304. In various embodiments, landmark detection engine 202 also generates a confidence score for each predicted landmark. In some embodiments, more than one landmark points and confidence scores are generated by landmark detection engine 202 corresponding to different query points provided as input. In other embodiments, the landmark detection engine 202 allows predicting interpolated landmarks. This enables users to generate denser landmark layouts from existing sparse landmark layouts.

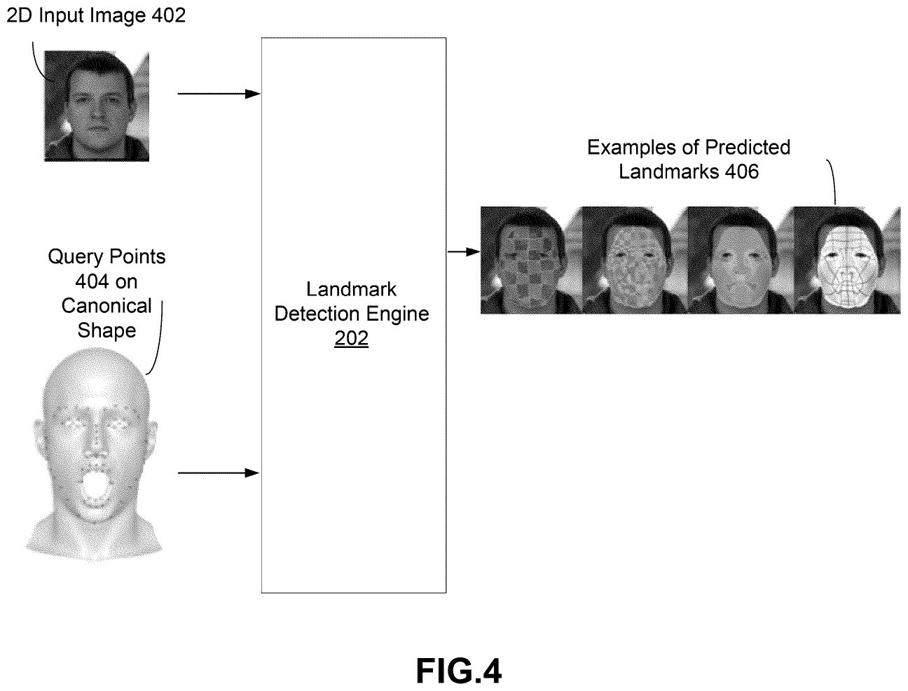

FIG. 4 illustrates the application of landmark detection engine 202 in FIG. 2 to facial segmentation, according to various embodiments. In facial segmentation, an input image or a video frame is divided into regions, where each region has a shared semantic meaning. For example, an image of a face may be segmented into different regions, where each region represents a different part of the face (e.g., the nose, lips, eyes, etc.).

For the facial segmentation application, landmark detection engine 202 receives as input a 2D image 402 and a dense set of query points 404 on the canonical shape. Landmark detection engine 202 processes 2D image 402 and the dense set of query points 404 to generate dense segmentation landmarks corresponding to the set of query points 404. A dense set of query points is a set of tightly spaced points on the 3D canonical shape 404, which represent more accurately the surface or volume of a 3D shape. As shown, FIG. 4 illustrates different examples of predicted landmarks 406, each corresponding to a different way of illustrating a segmentation mark overlayed on the input image 402 based on the landmarks predicted from the query points 404.

Landmark detection engine 202 can predict sparse or dense landmarks, both on the face and off surface, allowing applications beyond traditional landmark detection. In some embodiments, landmark detection engine 202 predicts arbitrarily dense landmarks, which can be overlayed on 2D input image 402 as facial segmentation masks. In other embodiments, a user can segment the face into multiple or arbitrary layouts on the 3D canonical shape 404 based on dense landmarks generated by landmark detection engine 202 for each segment class.

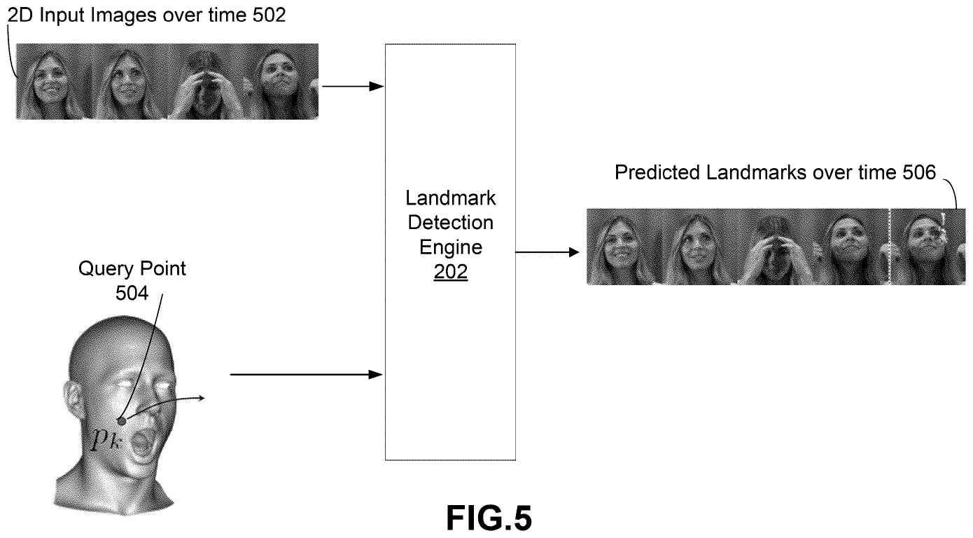

FIG. 5 illustrates the application of landmark detection engine 202 in FIG. 2 to user-specific landmark tracking, according to various embodiments. In user-specific landmark tracking, a user defines one or more points on a canonical shape that are to be tracked. For example, a user may specify particular points on the canonical shape corresponding to a person's face, like moles or blemishes that are to be tracked. Landmark detection engine 202 generates landmarks corresponding to the specified points over a series of frames in a video or additional images of that person.

For the user-specific landmark tracking application, landmark detection engine 202 receives as input a series of 2D input images over time 502 and a query point 504 on the 3D canonical shape. Landmark detection engine 202 generates a set of predicted landmarks over time based on the inputs. In some embodiments, all predicted landmarks over time 506 are superimposed on a frame of the video to facilitate tracking of the specified point over time. In this application, landmark detection engine 202 also tracks any user-defined image feature across a video and is capable of handling frames where the face point is occluded.

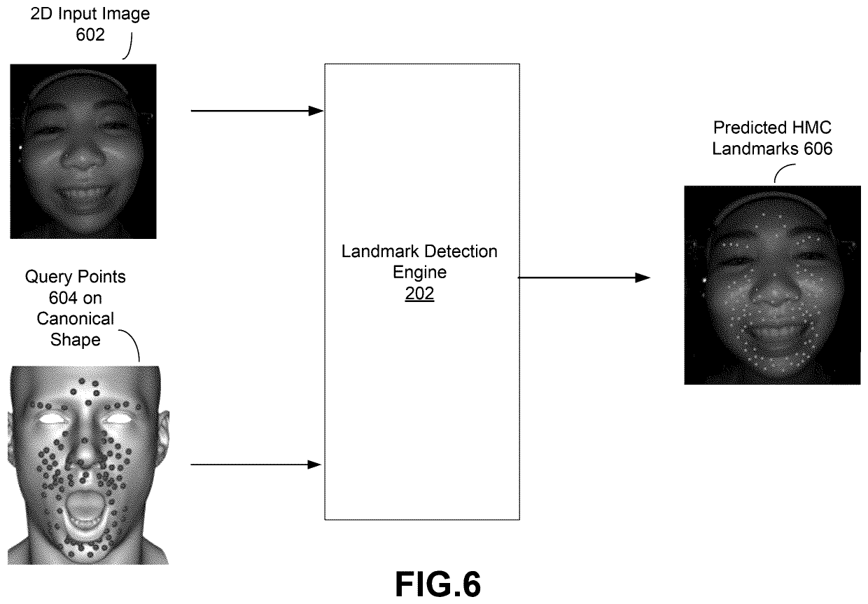

FIG. 6 illustrates the application of landmark detection engine 202 in FIG. 2 to face tracking in Helmet-Mounted Camera (HMC) images, according to various embodiments. In face tracking, a user can annotate a single frame of a video, and landmark detection engine 202 can track facial annotations throughout the remaining video. These annotations are a configuration of landmarks on the surface of the 3D canonical shape defined by the user for their desired application. The configuration of annotations can be dense, sparse or any other layout. Landmark detection engine 202 receives a video or 2D input images 602 recorded by a HMC and query points 604 on the 3D canonical shape. This landmark layout on the 3D canonical shape can be arbitrary and is provided to the landmark detection engine 202 at runtime. Landmark detection engine 202 generates a set of landmarks 606 based on 2D input image 602 and query points 604. In the HMC application shown in FIG. 6, the query points 604 may be generated via the query optimization process discussed above, where the query points 604 correspond to landmarks on an annotated input image, and landmark detection engine 202 is used to predict the same landmarks on 2D input image.

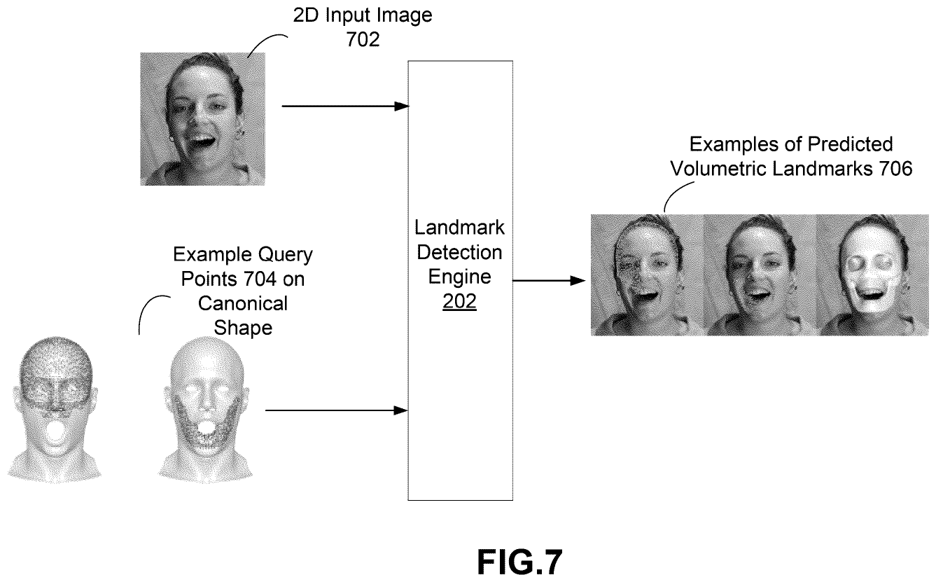

FIG. 7 illustrates an application of landmark detection engine 202 in FIG. 2 for predicting non-standard volumetric landmarks, according to various embodiments. As shown, these landmarks correspond to skull, jaw, teeth, and eyes. Landmark detection engine 202 provides plausible, temporally smooth 2D landmarks, which can be used to rigidly track 3D facial anatomy. For this application, landmark detection engine 202 receives a video or 2D input image 702 and various query points (such as example query points 704) as input. Landmark detection engine 202 generates predicted volumetric landmarks based on the received inputs. In some embodiments, the non-standard volumetric landmarks, for example corresponding to skull and jaw features, can be used to fit anatomical geometry. In other embodiments, the predicted landmarks corresponding to eyes can be used for eye tracking in real time.

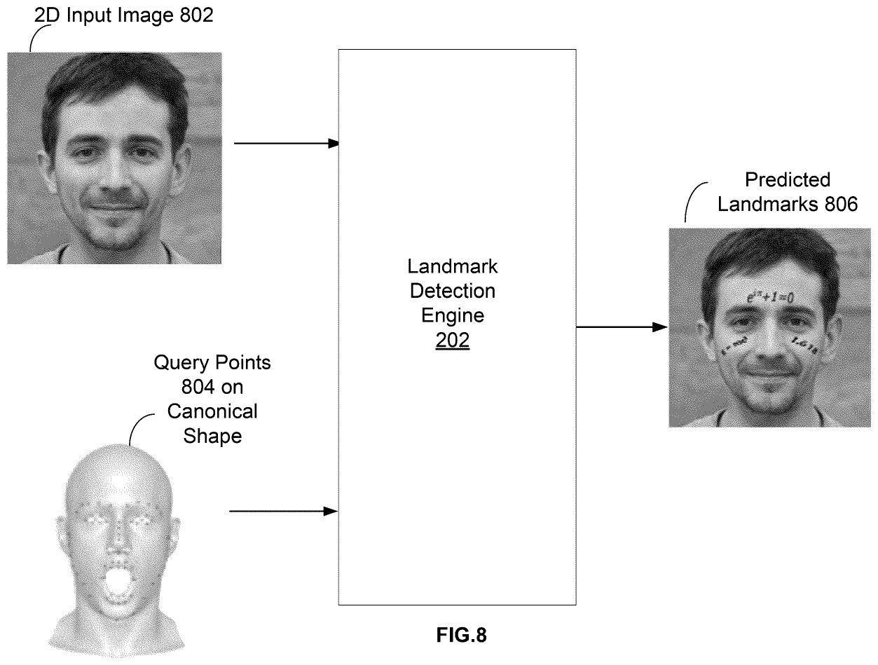

FIG. 8 illustrates an application of landmark detection engine 202 in FIG. 2 for 2D face editing, according to various embodiments. Landmark detection engine 202 enables applications, such as image and video face painting, without requiring an explicit 3D reconstruction of the face. This can be achieved by simply annotating or designing a given texture on the 3D canonical shape. Landmark detection engine 202 receives as input a video or 2D input images 802 and query points 804 on the 3D canonical shape. Landmark detection engine 202 predicts landmarks 806 806 where facial paintings should be overlayed based on the received inputs. In some embodiments, a texture can be propagated across multiple identities, expressions, and environments in a consistent manner.

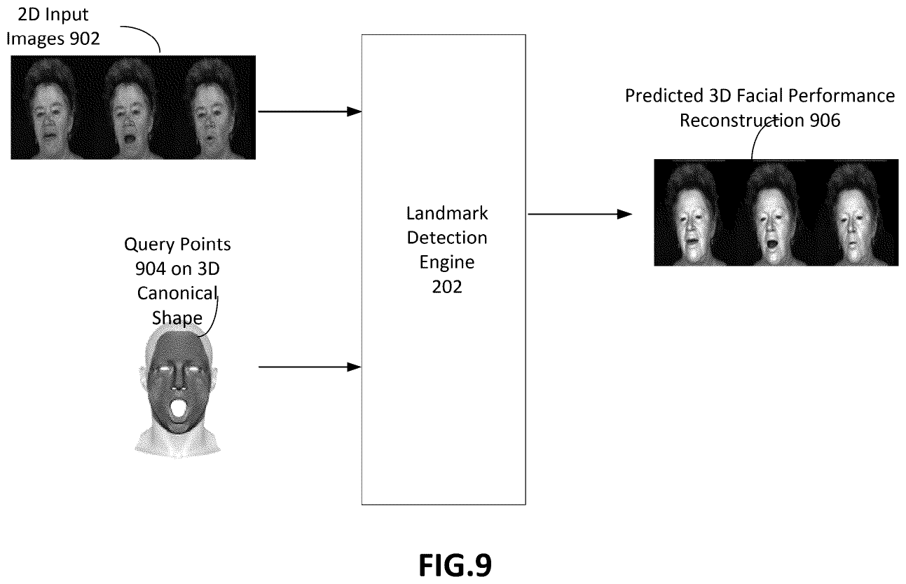

FIG. 9 illustrates an application of landmark detection engine 202 in FIG. 2 for 3D facial performance reconstruction, according to various embodiments. In this application, an actor specific face model is fitted to the landmarks predicted by landmark detection engine 202. As landmark detection engine 202 can predict an arbitrarily dense number of landmarks, these extremely dense landmarks can be used for face reconstruction in 3D. Landmark detection engine receives a video or 2D input images 902 and query points 904 the 3D canonical shape. Landmark detection engine 202 generates 3D facial performance reconstruction 906 based on the predicted landmarks.

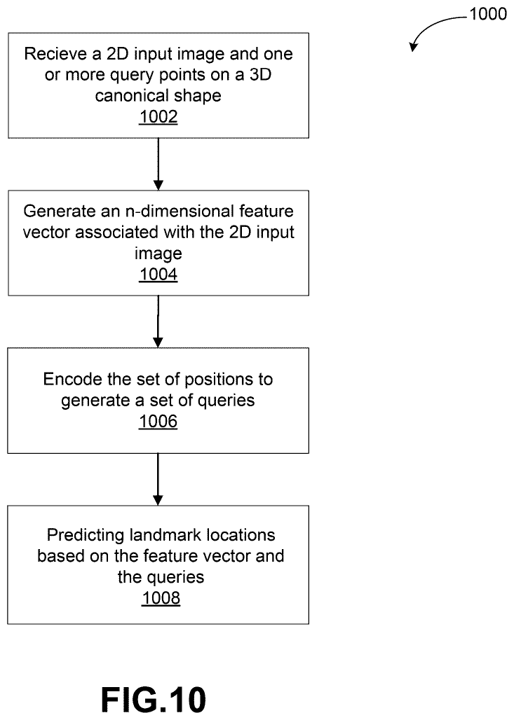

FIG. 10 is a flow diagram of method steps for predicting landmark locations, according to various embodiments. Although the method steps are described in conjunction with FIG. 1-3, persons skilled in the art will understand that any system configured to perform the method steps, in any order, falls within the scope of the present disclosure.

As shown method 1000 begins at step 10002, where execution engine 116 receives a 2D input image and one or more query points on a 3D canonical shape. In various embodiments, a query point corresponds to a landmark that a user desires to predict via landmark detection engine 202. A user can define or select a position on the 3D canonical shape corresponding to the query point.

At step 1004, feature extractor 204 generates an n-dimensional feature vector associated with the received 2D input image. The feature vector includes a set of features representing facial characteristics of a face included in the received 2D input image. At step 1006, position encoder 206 encodes the received one or more query points to generate a compressed representation of the one or more query points. The compressed representation is referred to as queries. The encoding process involves a transformation of the query points to an abstract representation.

At step 1008, landmark predictor predicts landmarks corresponding to the query points and a scalar confidence value for each landmark using the feature vector and the one or more queries. The predicted landmarks may be output as points on an output image corresponding to the input image. In various applications, the predicted landmarks may be used for facial segmentation, eye tracking, facial reconstruction, or other applications.

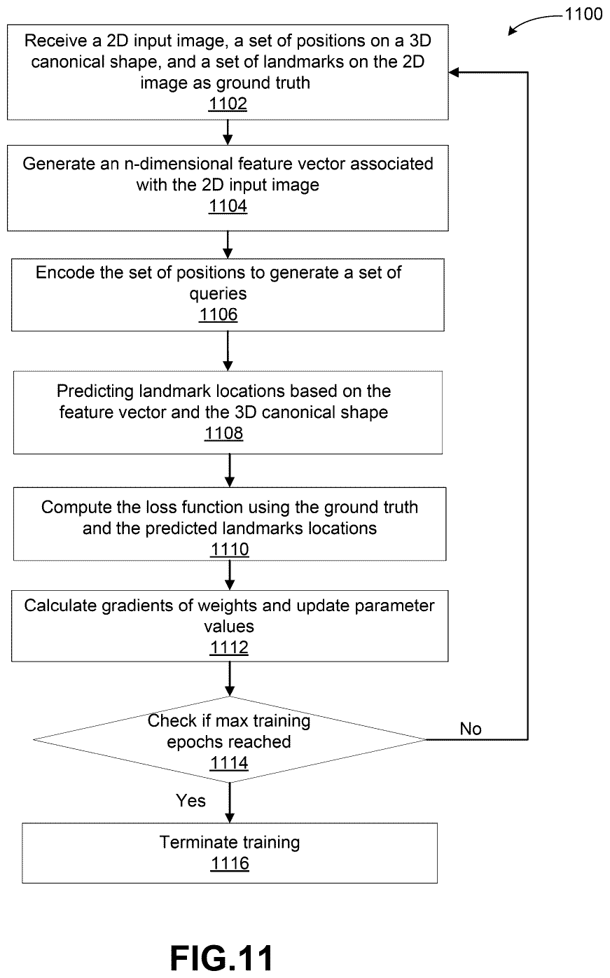

FIG. 11 is a flow diagram of method steps for training landmark detection model, according to various embodiments. Although the method steps are described in conjunction with FIG. 1-3, persons skilled in the art will understand that any system configured to perform the method steps, in any order, falls within the scope of the present disclosure.

As shown method 1100 begins a step 1102, where training engine 118 receives a series of 2D input images 210, one or more query points on the 3D canonical shape, and a set of ground truth landmarks from memory 102. At step 1104, feature extractor 204 generates an n-dimensional feature vector associated with the 2D input image. At step 1106, position encoder encodes the one query points on 3D canonical shape to generate one or more queries.

At step 1108, landmark predictor 208 predicts landmarks corresponding to the query points based on the feature vector and the queries. At step 1110, training engine 118 proceeds by computing the loss function using known landmarks in the training data and predicted landmark locations in addition to predicted confidence values for each landmark. Loss function is a mathematical formula that measures how well the neural network predictions align with the location of known landmarks in the training data. Next, at step 1112, training engine 118 calculates the gradients of weights and updates parameter values to be used in the next iteration of training. The weight determines the strength of the connections in a neural network.

At step 1114, training engine 118 determines whether the maximum number of training epochs has reached. If, at step 1114, the training engine 118 determines that maximum number of training epochs hasn't reached then, the method proceeds to step 1102, where training engine 118 receives a series of 2d input images 210, query points on 3d canonical shape 212 and a set of ground truth landmarks from memory 102.

In sum, the landmark detection engine predicts a set of landmarks on a two-dimensional image according to an arbitrary layout specified at runtime using a three-dimensional (3D) facial model. The 3D facial model corresponds to a template face and can be used to specify a layout for the desired set of landmarks to be predicted. The landmark detection engine includes at least three components. First, the landmark detection engine includes an image feature extractor that takes a normalized image of a face and generates an n-dimensional feature vector representative of the face in the input image. Second, the landmark detection engine includes a positional encoder that learns the mapping from positions on the 3D facial model to 3D position queries during training. The position queries specify positions for which landmarks are to be predicted. Third, the landmark detection engine includes a landmark predictor that operates on the feature vector generated by the landmark detection engine and the 3D position queries generated by the positional encoder to predict corresponding 2D landmark locations on the face included in the input image.

The disclosed techniques achieve various advantages over prior-art techniques. In particular, landmark models trained using the disclosed techniques result in continuous and unlimited landmark detection since the 3D query points can be arbitrarily chosen on facial 3D model. Because the landmark detection engine enables landmarks to be detected according to an arbitrary layout, the resulting landmarks can be continuous and dense allowing for many different downstream use cases. For example, the generated landmarks can be used in image segmentation applications, facial reconstruction, anatomy tracking, and many other applications. For example, the disclosed techniques can track non-standard landmarks like pores, moles or dots drawn by experts on the face without training a specific landmark predictor.

One technical advantage of the disclosed technique relative to the prior art is that the disclosed technique allows for landmarks to be generated according to a layout that is selected at runtime. In such a manner, landmarks can be predicted on input images in a continuous and arbitrary manner that satisfies a given application's requirement. These technical advantages provide one or more technological improvements over prior art approaches.

1. In some embodiments, a computer-implemented method comprises receiving an input image including one or more facial representations and a set of points associated with a 3D canonical shape, wherein the set of points are selectable at runtime, extracting a set of features from the input image that represent at least one facial representation included in the one or more facial representations, and determining a set of landmarks on the at least one facial representation based on the set of features and the set of points, wherein each landmark in the set of landmarks is associated with at least one point in the set of points.

2. The computer-implemented method of clause 1, further comprising encoding the set of points based on a latent representation to generate a set of position queries, wherein the set of landmark locations are generated using the set of position queries.

3. The computer-implemented method of clauses 1 or 2, wherein the 3D canonical shape comprises a fixed 3D object model of a face.

4. The computer-implemented method of any of clauses 1-3, wherein the set of points are positioned on or around the 3D canonical shape based on a desired layout of the set of landmarks.

5. The computer-implemented method of any of clauses 1-4, wherein the input image comprises a two-dimensional image captured by an image capture device.

6. The computer-implemented method of any of clauses 1-5, further comprising generating a facial segmentation mask associated with the at least one face based on the one or more landmarks, wherein the facial segmentation mask divides the at least one face into semantically meaningful regions.

7. The computer-implemented method of any of clauses 1-6, further comprising receiving a second input image including the at least one facial representation, wherein the second input image is captured at a different point in time from the input image, extracting a second set of features from the second input image that represent the at least one facial representation, determining a second set of landmarks on the at least one facial representation based on the second set of features and the set of points, wherein each landmark in the second set of landmarks is associated with at least one point in the set of points, comparing a first landmark in the set of landmarks and a second landmark in the second set of landmarks to perform facial tracking operations.

8. The computer-implemented method of any of clauses 1-7, further comprising receiving an annotated image including one or more landmarks, and determining, via query optimization, the set of points based on the one or more landmarks.

9. The computer-implemented method of any of claims 1-8, wherein the set of landmarks are determined using one or more trained machine learning models.

10. In some embodiments, one or more non-transitory computer readable media store instructions that, when executed by one or more processors, cause the one or more processors to perform the steps of receiving an input image including one or more facial representations and a set of points on a 3D canonical shape, wherein the set of points are selectable at runtime, extracting a set of features from the input image that represent at least one facial representation included in the one or more facial representations, and determining a set of landmarks on the at least one facial representation based on the set of features and the set of points, wherein each landmark in the set of landmarks is associated with at least one point in the set of points.

11. The one or more non-transitory computer readable media of clause 10, wherein the steps further comprise encoding the set of points based on a latent representation to generate a set of position queries, wherein the set of landmark locations are generated using the set of position queries.

12. The one or more non-transitory computer readable media of clauses 10 or 11, wherein the 3D canonical shape comprises a fixed 3D object model of a face.

13. The one or more non-transitory computer readable media of any of clauses 10-12, wherein the set of points are positioned on or around the 3D canonical shape based on a desired layout of the set of landmarks.

14. The one or more non-transitory computer readable media of any of clauses 10-13, wherein the input image comprises a two-dimensional image captured by an image capture device.

15. The one or more non-transitory computer readable media of any of clauses 10-14, wherein the steps further comprise generating a facial segmentation mask associated with the at least one face based on the one or more landmarks, wherein the facial segmentation mask divides the at least one face into semantically meaningful regions.

16. The one or more non-transitory computer readable media of any of clauses 10-15, wherein the steps further comprise receiving a second input image including the at least one facial representation, wherein the second input image is captured at a different point in time from the input image, extracting a second set of features from the second input image that represent the at least one facial representation, determining a second set of landmarks on the at least one facial representation based on the second set of features and the set of points, wherein each landmark in the second set of landmarks is associated with at least one point in the set of points, comparing a first landmark in the set of landmarks and a second landmark in the second set of landmarks to perform facial tracking operations.

17. The one or more non-transitory computer readable media of any of clauses 10-16, wherein the steps further comprise receiving an annotated image including one or more landmarks, and determining, via query optimization, the set of points based on the one or more landmarks.

18. The one or more non-transitory computer readable media of any of clauses 10-17, wherein the set of landmarks are determined using one or more trained machine learning models.

19. In some embodiments, a computer system comprises one or more memories, and one or more processors for receiving an input image including one or more facial representations and a set of points on a 3D canonical shape, wherein the set of points are selectable at runtime, extracting a set of features from the input image that represent at least one facial representation included in the one or more facial representations, and determining a set of landmarks on the at least one facial representation based on the set of features and the set of points, wherein each landmark in the set of landmarks is associated with at least one point in the set of points.

20. The computer system of clause 19, wherein the 3D canonical shape comprises a fixed 3D object model of a face.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
receiving an input image including one or more facial representations and a set of points associated with a 3D canonical shape, wherein the set of points are selectable at runtime;
extracting a set of features from the input image that represent at least one facial representation included in the one or more facial representations; and
determining a set of landmarks on the at least one facial representation based on the set of features and the set of points, wherein each landmark in the set of landmarks is associated with at least one point in the set of points.

2. The computer-implemented method of claim 1, further comprising encoding the set of points based on a latent representation to generate a set of position queries, wherein the set of landmark locations are generated using the set of position queries.

3. The computer-implemented method of claim 1, wherein the 3D canonical shape comprises a fixed 3D object model of a face.

4. The computer-implemented method of claim 1, wherein the set of points are positioned on or around the 3D canonical shape based on a desired layout of the set of landmarks.

5. The computer-implemented method of claim 1, wherein the input image comprises a two-dimensional image captured by an image capture device.

6. The computer-implemented method of claim 1, further comprising generating a facial segmentation mask associated with the at least one face based on the one or more landmarks, wherein the facial segmentation mask divides the at least one face into semantically meaningful regions.

7. The computer-implemented method of claim 1, further comprising:
receiving a second input image including the at least one facial representation, wherein the second input image is captured at a different point in time from the input image;
extracting a second set of features from the second input image that represent the at least one facial representation;
determining a second set of landmarks on the at least one facial representation based on the second set of features and the set of points, wherein each landmark in the second set of landmarks is associated with at least one point in the set of points;
comparing a first landmark in the set of landmarks and a second landmark in the second set of landmarks to perform facial tracking operations.

8. The computer-implemented method of claim 1, further comprising:
receiving an annotated image including one or more landmarks; and
determining, via query optimization, the set of points based on the one or more landmarks.

9. The computer-implemented method of claim 1, wherein the set of landmarks are determined using one or more trained machine learning models.

10. One or more non-transitory computer readable media storing instructions that, when executed by one or more processors, cause the one or more processors to perform the steps of:
receiving an input image including one or more facial representations and a set of points on a 3D canonical shape, wherein the set of points are selectable at runtime;
extracting a set of features from the input image that represent at least one facial representation included in the one or more facial representations; and
determining a set of landmarks on the at least one facial representation based on the set of features and the set of points, wherein each landmark in the set of landmarks is associated with at least one point in the set of points.

11. The one or more non-transitory computer readable media of claim 10, wherein the steps further comprise encoding the set of points based on a latent representation to generate a set of position queries, wherein the set of landmark locations are generated using the set of position queries.

12. The one or more non-transitory computer readable media of claim 10, wherein the 3D canonical shape comprises a fixed 3D object model of a face.

13. The one or more non-transitory computer readable media of claim 10, wherein the set of points are positioned on or around the 3D canonical shape based on a desired layout of the set of landmarks.

14. The one or more non-transitory computer readable media of claim 10, wherein the input image comprises a two-dimensional image captured by an image capture device.

15. The one or more non-transitory computer readable media of claim 10, wherein the steps further comprise generating a facial segmentation mask associated with the at least one face based on the one or more landmarks, wherein the facial segmentation mask divides the at least one face into semantically meaningful regions.

16. The one or more non-transitory computer readable media of claim 10, wherein the steps further comprise:
receiving a second input image including the at least one facial representation, wherein the second input image is captured at a different point in time from the input image;
extracting a second set of features from the second input image that represent the at least one facial representation;
determining a second set of landmarks on the at least one facial representation based on the second set of features and the set of points, wherein each landmark in the second set of landmarks is associated with at least one point in the set of points;
comparing a first landmark in the set of landmarks and a second landmark in the second set of landmarks to perform facial tracking operations.

17. The one or more non-transitory computer readable media of claim 10, wherein the steps further comprise:
receiving an annotated image including one or more landmarks; and
determining, via query optimization, the set of points based on the one or more landmarks.

18. The one or more non-transitory computer readable media of claim 10, wherein the set of landmarks are determined using one or more trained machine learning models.

19. A computer system, comprising:
one or more memories; and
one or more processors for:
receiving an input image including one or more facial representations and a set of points on a 3D canonical shape, wherein the set of points are selectable at runtime;
extracting a set of features from the input image that represent at least one facial representation included in the one or more facial representations; and
determining a set of landmarks on the at least one facial representation based on the set of features and the set of points, wherein each landmark in the set of landmarks is associated with at least one point in the set of points.

20. The computer system of claim 19, wherein the 3D canonical shape comprises a fixed 3D object model of a face.
